(19) United States
(12) Patent Application Publication
(10) Pub. No.: US 2019/0342186 A1
(43) Pub. Date: Nov. 7, 2019

(54) SERVICE LEVEL PERFORMANCE ASSURANCE IN A SOFTWARE DEFINED NETWORK

(71) Applicant: AT&T Intellectual Property I, L.P., Atlanta, GA (US)

(72) Inventors: Xiaowen Mang, Morganville, NJ (US); Carolyn Roche Johnson, Holmdel, NJ (US)

(21) Appl. No.: 15/969,551

(22) Filed: May 2, 2018

(51) Int. Cl. H04L 12/24; H04L 29/08; H04L 12/26; G06F 9/455

(52) U.S. Cl. CPC H04L 41/5009; H04L 67/18; H04L 67/34; G06F 9/455; H04L 41/14; H04L 43/0852

(57) ABSTRACT

The transport latency, processing time, and computing time in virtual functions (VFs) and physical functions (PFs) that are allocated to delay sensitive services may be assessed and stored. The assessment may be used to create latency zones for network planning or design, as well as determining in near real time the available resources to meet the service needs.

### TECHNICAL FIELD

The technical field generally relates to network planning and design and, more specifically, to systems and methods for managing service level performance assurance in a network.

### BACKGROUND

Telecommunication carriers are faced with an explosive growth in mobile traffic, as all varieties of applications are communicating over cellular networks. To meet the increasing demand, large amounts of new infrastructure will be needed, which leads to huge capital expenses and operational costs. The new technology may be utilized to expand the capacity of the networks, while keeping expenses relatively low.

### SUMMARY

The disclosed system may assess the transport latency, processing time, and computing time in virtual functions (VFs) and physical functions (PFs) that are allocated to delay sensitive services. This assessment may assist in efficiently managing VFs and PFs that are assigned to these delay sensitive services.

Methods, systems, and apparatuses, among other things, as described herein may provide for obtaining a first request, the first request associated with creating a latency zone associated with a network access point; based on the first request, determining latency measurements between a network access point and a plurality of network devices, wherein a first network device and a second device house a service; and mapping the latency measurements between the network access point and the plurality of network devices to a latency zone for the base station.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates exemplary system that displays relative geographic locations of network devices.

FIG. 2 illustrates an exemplary latency zone that displays relative latencies of network devices as measured from a network access point.

FIG. 3 illustrates an exemplary method for generating a latency zone.

FIG. 4 illustrates an exemplary method associated with update of virtual or physical equipment.

FIG. 5 illustrates an exemplary method associated with periodic performance monitoring or measurement.

FIG. 6 illustrates a schematic of an exemplary network device.

FIG. 7 illustrates an exemplary communication system that provides wireless telecommunication services over wireless communication networks.

FIG. 8a illustrates an exemplary SDN-related telecommunications system in which the disclosed methods and processes may be implemented.

FIG. 8b illustrates an exemplary implementation of an SDN-related hardware platform.

### DETAILED DESCRIPTION

As disclosed in more detail herein, the transport latency, processing time, and computing time in virtual functions (VFs) and physical functions (PFs) that are allocated to delay sensitive services may be assessed and stored. The assessment may be used to create latency zones for network planning or design, as well as determining in near real time the available resources to meet the service needs.

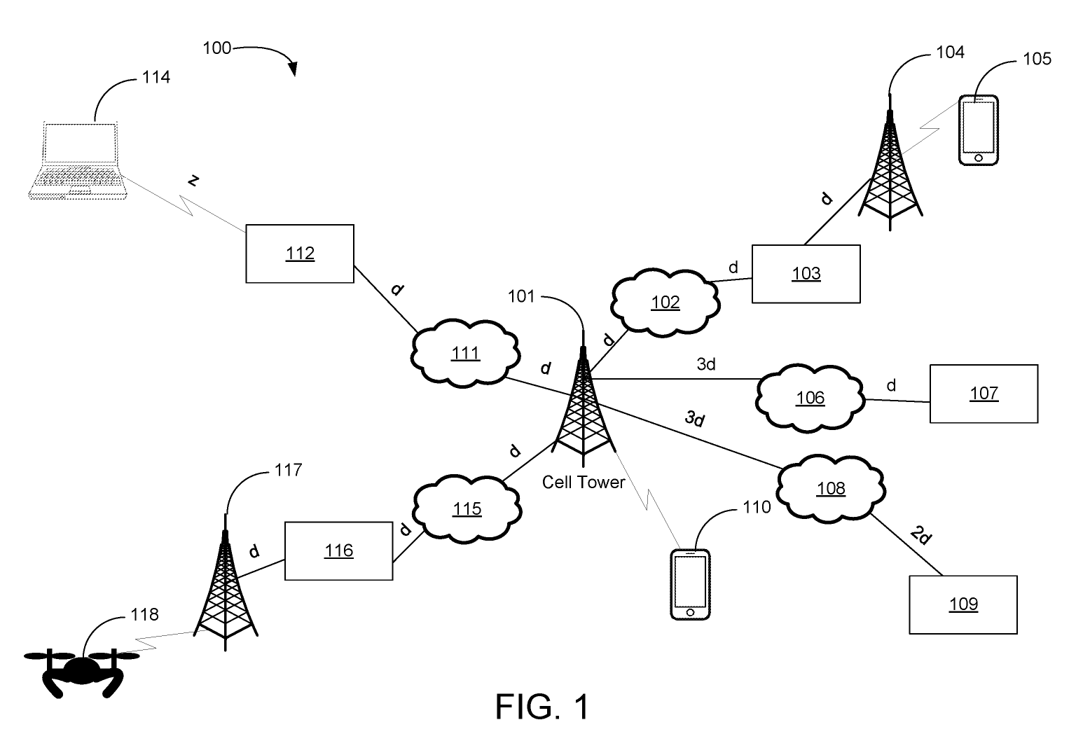

FIG. 1 illustrates exemplary system that displays relative geographic locations of network devices. FIG. 1 is not to scale, but provides perspective with regard to relative geographic locations of devices in exemplary system 100. Base station 101 (e.g., 3G, 4G, 5G, or Wi-Fi base station) may be communicatively connection with a plurality of devices across system 100. Mobile device 110 may be connected communicate with customer desktop computer 114 (e.g., customer premise equipment). This connection may go through multiple network elements, such as base station 101, network cloud 111, and network device 112 (e.g., gateway router). Network cloud 111 may contain several network devices that route, switch, or otherwise assist in connecting mobile device 110 to customer desktop computer 114. Each device or network element may be a certain distance from each other (for simplicity of illustration each segment is some multiple of length “d”).

With continued reference to FIG. 1, there are other network elements that are part of system 100 and communicatively connected with each other. There are several network clouds as shown, such as network cloud 102, network cloud 106, network cloud 108, and network cloud 115. Generally, network clouds may include devices that are commonly found in a central office or like facility and affect data or voice communication. There are several base stations shown in FIG. 1, such as base station 104 and base station 117. FIG. 1 also include network devices (e.g., network device 116, network device 109, network device 107, and network device 103) and user equipment devices (e.g., mobile device 105 and mobile device 118). The network devices may be servers for services (e.g., virtual network functions) or may be gateway devices (e.g., gateway router or gateway switch), among other things.

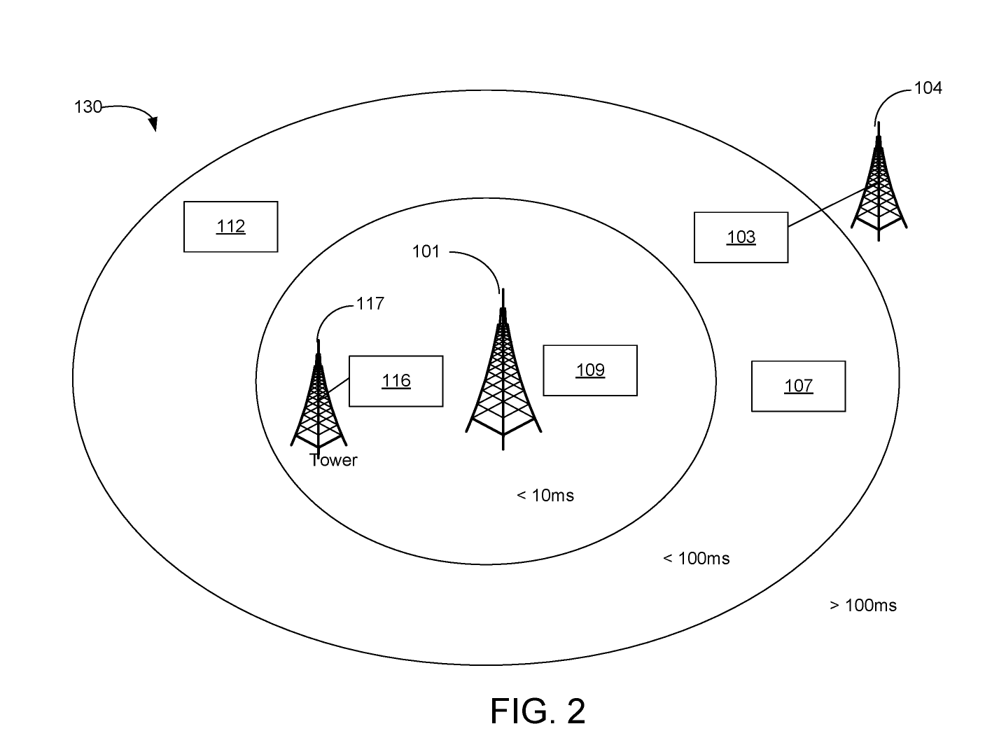

FIG. 2 illustrates an exemplary latency zone 130 that displays relative latencies of network devices as measured from base station 101. A latency zone may establish a one to many association between a network access point, such as a base station, to other network resources or entities, such as routers or servers. That association may be based on a predefined latency limit from the network access point to other network resources. Base station 101, in this example, is the center of the latency zone 130 and circles (e.g., bands) radiate away from base station 101 to indicate different latency levels (e.g., bands) of latency zone 130. It is contemplated herein that latency zone 130 (which may include one or more bands) may be shown in multiple different ways using polygonal, elliptical, or other shapes. As shown, the apparatuses that are within 10 ms of base station 101 may include base station 117, network device 116, and network device 109. Apparatuses (also referred to herein as devices) that are within 100 ms of base station 101 may include network device 103, network device 112, and network device 107. Base station 104 is greater than 100 ms away from base station 101. As illustrated by FIG. 2 and FIG. 1, it is understood that distance by itself is not necessarily the determining factor for what apparatuses may be determined to be within a band (e.g., <10 ms vs <100 ms) of latency zone 130. User equipment devices are not shown in the latency zone, but could be accounted for if desired. The preferred configuration may have service providers only keeping track of their equipment and not considering last mile or other issues that may be customer premise equipment or user equipment centric. Disclosed below is more detail with regard to the creation and use of latency zone 130.

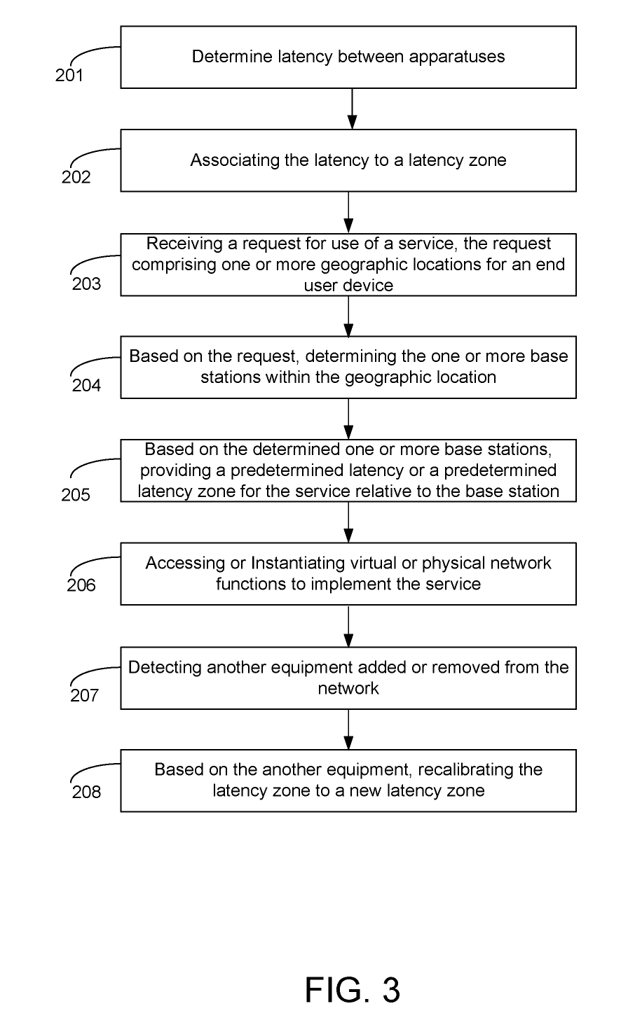

FIG. 3 illustrates an exemplary method for generating, using, and managing a latency zone. The method may be implemented in one or more devices as shown in FIG. 1. At step 201, latency between apparatuses (e.g., network device 116, base station 117, or other apparatuses of FIG. 1) and network access point (NAP) (e.g., base station 101) may be determined. Latency may be obtained through testing (e.g., ping, speed tests, or other applications) that may occur at different times of day. Latency may also be determined based on hardware and distance (e.g., conventional latency over fiber plus conventional latency of each intermediary device/apparatus). Pings (or the like latency tests) may be sourced from base station 101, pings may be sourced from the service equipment, or pings may be sourced from some combination of the aforementioned. At step 202, based on the determined latency between apparatuses and base stations, associating the latency and appropriate apparatuses to latency zone 130. Latency zone 130 may include values of a predetermined average or median or the like value of latency for apparatuses. It is contemplated herein that a latency zone may be relative to any apparatus (e.g., network device 116), but base stations are used for simplicity. It also contemplated that latency zone 130 may be based on time, therefore latency zone 130 at 2:00 PM may be different that latency zone 130 at 5 AM.

With continued reference to FIG. 3, at step 203, a request may be received for use of a service (e.g., video service, automated drone delivery service, virtual private network service, etc). The request may comprise one or more geographic locations, which may be associated with an end user device (e.g., mobile device 110). Alternatively, the request may include request to know about the services associated with the base station or a request to know the latency zone associated with base station, among other things. The request may include the maximum latency needed for the service (e.g., service 1 with 6 ms vs. service 1 with 11 ms). Requirements included in the request may restrict what is displayed (e.g., step 205) or otherwise provided (e.g., step 206). At step 204, based on the request of step 203, determining the one or more base stations within the one or more geographic locations.

With continued reference to FIG. 3, at step 205, based on the determined one or more base stations, providing a predetermined latency or a predetermined latency zone 130 for the service relative to the base station (or possibly the end user device). The predetermined latency or predetermined latency zone 130 may be an alphanumeric combination (e.g., 6 ms, less than 10 ms, etc. . . . ) or displayed graph or drawing (e.g., FIG. 2) of the service inquired about in step 203 or multiple services associated with the base station, among other things.

At step 206, a virtual network function (or the like) may be accessed or instantiated to implement the service corresponding to a device determined to be within the latency zone so that the end user can use the service. For example, network device 109 before the request at step 201 may have the hardware specifications, but not the service (e.g., virtual function) installed or otherwise activated. At this step 206, since network device 109 is within 10 ms (assuming it matches the requirement), then the service may be automatically instantiated on network device 109. Between network device 109 and base station (BS) or network access point (NAP), there can be multiple paths that connect BS/NAP and network device 109. The one that has smallest latency and satisfy other service requirements, such as bandwidth or service specific features should be chosen. VNFs on network devices along the chosen path (between BS/NAP and network device 109) should be accessed or instantiated.

With continued reference to FIG. 3, at step 207, there may be a detection of another apparatus added or removed from system 100. It is also contemplated that it may be virtual function instead of physical hardware equipment. At step 208, based on the apparatus (e.g., type of equipment—router, switch, relay, memory, processor, server, etc.), recalibrating the latency zone to a new latency zone 130. It is contemplated herein that for virtual network function it may be the type of VNF, which may affect how other VNFs operate or the like. Step 201 or step 202 may be repeated for each addition or subtraction of equipment. Also, it is contemplated that the type of latency test in step 201 may be different based on the equipment. For example, for a router a ping test may be used. For a relay a determination based on general specifications (e.g., expected reduction or increase in latency based on historical information, which may include manufacture specifications) may be used.

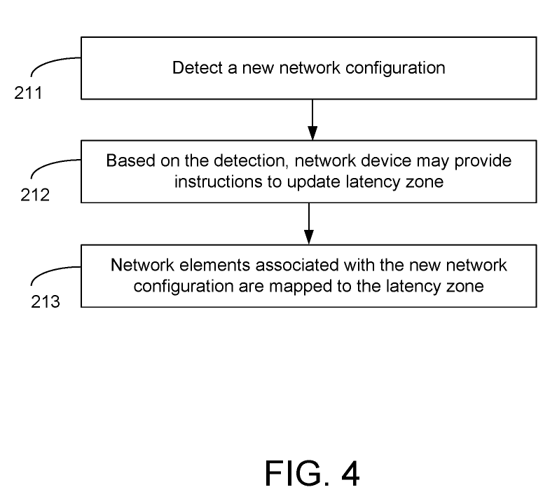

FIG. 4 illustrates an exemplary method associated with update of virtual or physical equipment (e.g., similar to step 206-step 207). At step 211, a network management system (e.g., located in network device 103) may detect a new network configuration (e.g., network devices which may be part of a new data center or expansion of an existing data center). At step 212, based on the detection, network device 103 may provide instructions to update latency zone 130. The instructions may be sent to another device to do latency tests for subsequent mapping or network device 103 may use historical information (as disclosed herein) to determine latency. The trigger of step 212, may be based on reaching a threshold of added or deleted devices, a time of day of added or deleted devices, location of devices, or any combination of the aforementioned, among other things. At step 213, network elements associated with the new network configuration are mapped to the latency zone as appropriate.

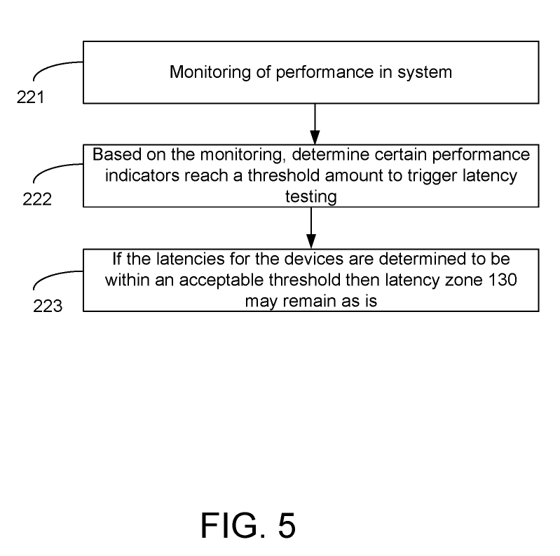

FIG. 5 illustrates an exemplary method associated with periodic performance monitoring or measurement. At step 221, continuous or periodic monitoring of performance may be done in system 100. At step 222, based on the monitoring, a network management system (e.g., located in network device 103) may determine certain performance indicators reach a threshold amount to trigger latency testing. For example, a key performance indicator that may be associated with processor speed reaching a 90% threshold (or memory usage reaching a 70% threshold) of base station 101 may trigger latency tests for one or more devices communicatively connected with base station 101. The threshold of how many devices are tested may be based on historical patterns (e.g., services used most), geographical location (e.g., within 100 miles), or the like. At step 223, if the latencies for the devices are determined to be within an acceptable threshold (e.g., mean latency is as expected) then latency zone 130 may remain as is. But if the latency is outside an acceptable threshold (which may be further based on a certain percentage (e.g., 20%) of a subset of devices), then there may be remapping of physical function (e.g., traditional server functions or router functions that do not run in virtual machines) or virtual function elements to latency zones for base station 101. Performance indicators may include device, customer premises equipment, or other access technology processing time. Performance indicators may include radio access network (RAN) or device to service provider point of interface latency. In addition, performance indicators may include packet processing time, virtual function or packet function computing time, or transport latency. In an example, computing time may refer to time taken to complete a task in a virtual machine.

Disclosed below are considerations that may be associated with requests for a service or managing a service associated with latency zone 130. The below may take into account to determine the management of the latency zone as described herein. There may be a service descriptor that specifies the service characteristics, such as performance targets, nature of applications, required network resource, among other things. A policy engine may populate any constraints on resource consumption such as the bandwidth limit, quality of service treatment, or concurrent sessions, among other things. A network management system may determine intermediate elements (e.g., elements of network cloud 115) that it can further optimize the network resources (e.g., remove files to increase memory and therefore performance), while take considerations of all necessary network and service constraints

Disclosed below is an approach to estimate delays for a request of service (e.g., step 203), which may be applicable to a network slicing architecture. A network slicing architecture is a form of virtual network architecture using the same principles behind software defined networking (SDN) and network functions virtualization (NFV) in fixed networks. SDN and NFV are now being commercially deployed to deliver greater network flexibility by allowing traditional network architectures to be partitioned into virtual elements that can be linked (also through software). Network slicing allows multiple virtual networks to be created on top of a common shared physical infrastructure. The virtual networks are then customized to meet the specific needs of applications, services, devices, customers or operators. It facilitates distinguishing prioritization among service requests and decides allocated resources. A request for service may have an end-to-end round trip delay (E2E RTD) target defined. Different services may have the same E2E RTD target assigned. For example, ultra-low latency (ULL) services may include augmented reality (AR), virtual reality (VR), connected cars, or drones, among other things. Services may be grouped into a few manageable categories. End user device (e.g., drone 118 or mobile device 110) processing time target may be defined. End user device may be grouped into a few manageable categories. An E2E network level latency target may be derived. A service request profile may be linked to E2E RTD target category and UE (also referred herein as end user device) category. When creating a resource slice for a service request, a set of network functional units (VNF) may be assigned. VNFs may be assigned a target processing time. VNFs may be assigned a target computing time if applied. Different VNFs may be assigned the same processing time target. Different VNFs may be assigned the same computing time target. Queueing delays may or may not be included. If queuing delays are not include, there may be an assumption that delay sensitive services are treated with quality of service (QoS) differentiation where queueing delays should be minimized. LTE, 5G, wifi, and future technologies that use SDN are applicable to the subject matter disclosed herein.

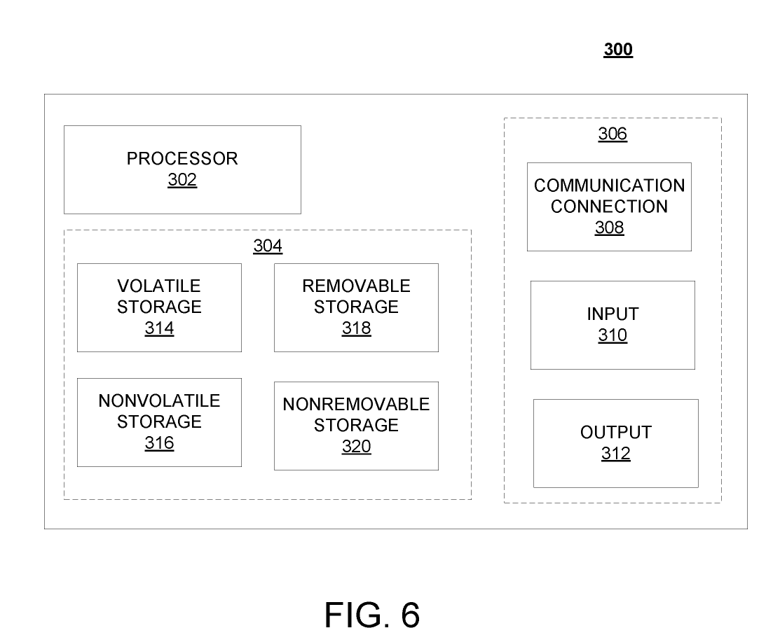

FIG. 6 is a block diagram of network device 300 that may be connected to or comprise a component of drone 118, mobile device 110, or other devices of system 100. Network device 300 may comprise hardware or a combination of hardware and software. The functionality to facilitate telecommunications via a telecommunications network may reside in one or combination of network devices 300. Network device 300 depicted in FIG. 6 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 6 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength. As evident from the description herein, network device 300 is not to be construed as software per se.

In addition to processor 302 and memory 304, network device 300 may include an input/output system 306. Processor 302, memory 304, and input/output system 306 may be coupled together (coupling not shown in FIG. 6) to allow communications between them. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

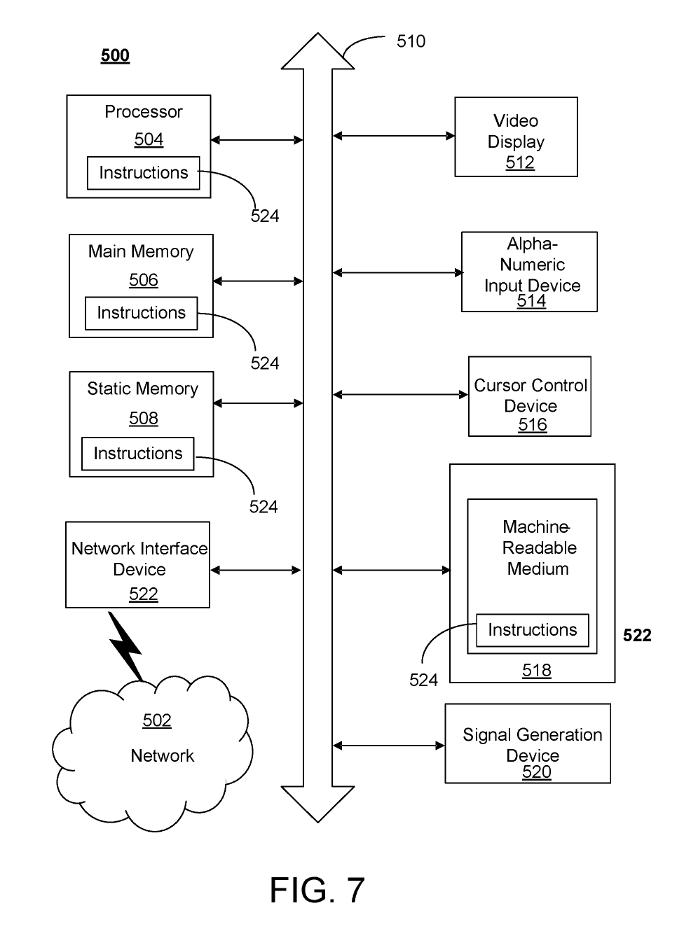

FIG. 7 depicts an exemplary diagrammatic representation of a machine in the form of a computer system 500 within which a set of instructions, when executed, may cause the machine to perform any one or more of the methods described above. One or more instances of the machine can operate, for example, as processor 302, mobile device 110, drone 118, network device 116, base station 117, and other devices of FIG. 1 and FIG. ZZ8. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

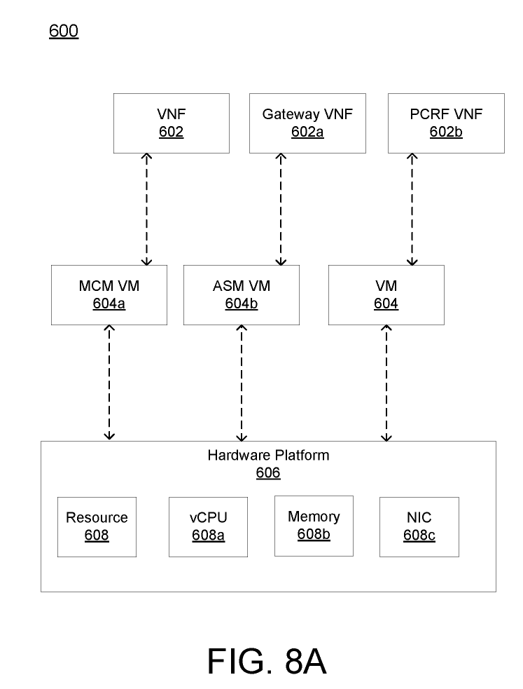

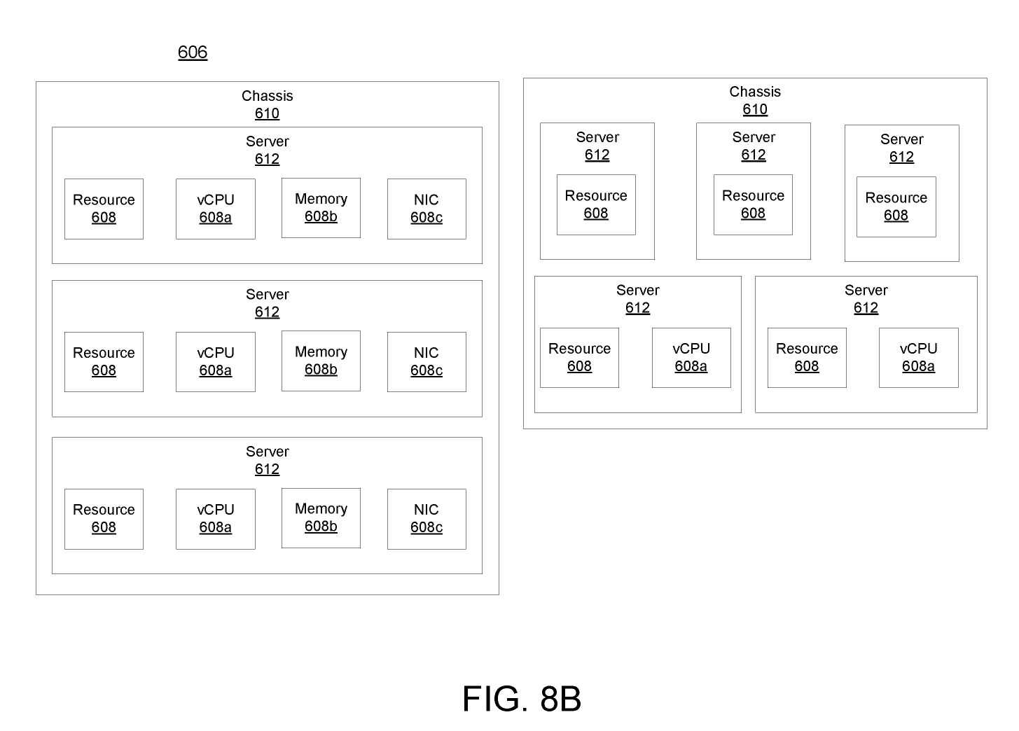

FIG. 8a is a representation of an exemplary network 600. Network 600 (e.g., system 100) may comprise an SDN—that is, network 600 may include one or more virtualized functions implemented on general purpose hardware, such as in lieu of having dedicated hardware for every network function. That is, general purpose hardware of network 600 may be configured to run virtual network elements to support communication services, such as mobility services, including consumer services and enterprise services. These services may be provided or measured in sessions.

A virtual network functions (VNFs) 602 may be able to support a limited number of sessions. Each VNF 602 may have a VNF type that indicates its functionality or role. For example, FIG. 8a illustrates a gateway VNF 602a and a policy and charging rules function (PCRF) VNF 602b. Additionally or alternatively, VNFs 602 may include other types of VNFs. Each VNF 602 may use one or more virtual machines (VMs) 604 to operate. Each VM 604 may have a VM type that indicates its functionality or role. For example, FIG. 8a illustrates a management control module (MCM) VM 604a, an advanced services module (ASM) VM 604b, and a DEP VM 604c. Additionally or alternatively, VMs 604 may include other types of VMs. Each VM 604 may consume various network resources from a hardware platform 606, such as a resource 608, a virtual central processing unit (vCPU) 608a, memory 608b, or a network interface card (NIC) 608c. Additionally or alternatively, hardware platform 606 may include other types of resources 608.

While FIG. 8a illustrates resources 608 as collectively contained in hardware platform 606, the configuration of hardware platform 606 may isolate, for example, certain memory 608c from other memory 608c. FIG. 8b provides an exemplary implementation of hardware platform 606.

Hardware platform 606 may comprise one or more chasses 610. Chassis 610 may refer to the physical housing or platform for multiple servers or other network equipment. In an aspect, chassis 610 may also refer to the underlying network equipment. Chassis 610 may include one or more servers 612. Server 612 may comprise general purpose computer hardware or a computer. In an aspect, chassis 610 may comprise a metal rack, and servers 612 of chassis 610 may comprise blade servers that are physically mounted in or on chassis 610.

Each server 612 may include one or more network resources 608, as illustrated. Servers 612 may be communicatively coupled together (not shown) in any combination or arrangement. For example, all servers 612 within a given chassis 610 may be communicatively coupled. As another example, servers 612 in different chasses 610 may be communicatively coupled. Additionally or alternatively, chasses 610 may be communicatively coupled together (not shown) in any combination or arrangement.

The characteristics of each chassis 610 and each server 612 may differ. For example, FIG. 8b illustrates that the number of servers 612 within two chasses 610 may vary. Additionally or alternatively, the type or number of resources 610 within each server 612 may vary. In an aspect, chassis 610 may be used to group servers 612 with the same resource characteristics. In another aspect, servers 612 within the same chassis 610 may have different resource characteristics.

Given hardware platform 606, the number of sessions that may be instantiated may vary depending upon how efficiently resources 608 are assigned to different VMs 604. For example, assignment of VMs 604 to particular resources 608 may be constrained by one or more rules. For example, a first rule may require that resources 608 assigned to a particular VM 604 be on the same server 612 or set of servers 612. For example, if VM 604 uses eight vCPUs 608a, 1 GB of memory 608b, and 2 NICs 608c, the rules may require that all of these resources 608 be sourced from the same server 612. Additionally or alternatively, VM 604 may require splitting resources 608 among multiple servers 612, but such splitting may need to conform with certain restrictions. For example, resources 608 for VM 604 may be able to be split between two servers 612. Default rules may apply. For example, a default rule may require that all resources 608 for a given VM 604 must come from the same server 612.

An affinity rule may restrict assignment of resources 608 for a particular VM 604 (or a particular type of VM 604). For example, an affinity rule may require that certain VMs 604 be instantiated on (that is, consume resources from) the same server 612 or chassis 610. For example, if VNF 602 uses six MCM VMs 604a, an affinity rule may dictate that those six MCM VMs 604a be instantiated on the same server 612 (or chassis 610). As another example, if VNF 602 uses MCM VMs 604a, ASM VMs 604b, and a third type of VMs 604, an affinity rule may dictate that at least the MCM VMs 604a and the ASM VMs 604b be instantiated on the same server 612 (or chassis 610). Affinity rules may restrict assignment of resources 608 based on the identity or type of resource 608, VNF 602, VM 604, chassis 610, server 612, or any combination thereof.

An anti-affinity rule may restrict assignment of resources 608 for a particular VM 604 (or a particular type of VM 604). In contrast to an affinity rule—which may require that certain VMs 604 be instantiated on the same server 612 or chassis 610—an anti-affinity rule requires that certain VMs 604 be instantiated on different servers 612 (or different chasses 610). For example, an anti-affinity rule may require that MCM VM 604a be instantiated on a particular server 612 that does not contain any ASM VMs 604b. As another example, an anti-affinity rule may require that MCM VMs 604a for a first VNF 602 be instantiated on a different server 612 (or chassis 610) than MCM VMs 604a for a second VNF 602. Anti-affinity rules may restrict assignment of resources 608 based on the identity or type of resource 608, VNF 602, VM 604, chassis 610, server 612, or any combination thereof.

Within these constraints, resources 608 of hardware platform 606 may be assigned to be used to instantiate VMs 604, which in turn may be used to instantiate VNFs 602, which in turn may be used to establish sessions. The different combinations for how such resources 608 may be assigned may vary in complexity and efficiency. For example, different assignments may have different limits of the number of sessions that can be established given a particular hardware platform 606.

For example, consider a session that may require gateway VNF 602a and PCRF VNF 602b. Gateway VNF 602a may require five VMs 604 instantiated on the same server 612, and PCRF VNF 602b may require two VMs 604 instantiated on the same server 612. (Assume, for this example, that no affinity or anti-affinity rules restrict whether VMs 604 for PCRF VNF 602b may or must be instantiated on the same or different server 612 than VMs 604 for gateway VNF 602a.) In this example, each of two servers 612 may have sufficient resources 608 to support 10 VMs 604. To implement sessions using these two servers 612, first server 612 may be instantiated with 10 VMs 604 to support two instantiations of gateway VNF 602a, and second server 612 may be instantiated with 9 VMs: five VMs 604 to support one instantiation of gateway VNF 602a and four VMs 604 to support two instantiations of PCRF VNF 602b. This may leave the remaining resources 608 that could have supported the tenth VM 604 on second server 612 unused (and unusable for an instantiation of either a gateway VNF 602a or a PCRF VNF 602b). Alternatively, first server 612 may be instantiated with 10 VMs 604 for two instantiations of gateway VNF 602a and second server 612 may be instantiated with 10 VMs 604 for five instantiations of PCRF VNF 602b, using all available resources 608 to maximize the number of VMs 604 instantiated.

Consider, further, how many sessions each gateway VNF 602a and each PCRF VNF 602b may support. This may factor into which assignment of resources 608 is more efficient. For example, consider if each gateway VNF 602a supports two million sessions, and if each PCRF VNF 602b supports three million sessions. For the first configuration—three total gateway VNFs 602a (which satisfy the gateway requirement for six million sessions) and two total PCRF VNFs 602b (which satisfy the PCRF requirement for six million sessions)—would support a total of six million sessions. For the second configuration—two total gateway VNFs 602a (which satisfy the gateway requirement for four million sessions) and five total PCRF VNFs 602b (which satisfy the PCRF requirement for 15 million sessions)—would support a total of four million sessions. Thus, while the first configuration may seem less efficient looking only at the number of available resources 608 used (as resources 608 for the tenth possible VM 604 are unused), the second configuration is actually more efficient from the perspective of being the configuration that can support more the greater number of sessions.

To solve the problem of determining a capacity (or, number of sessions) that can be supported by a given hardware platform 605, a given requirement for VNFs 602 to support a session, a capacity for the number of sessions each VNF 602 (e.g., of a certain type) can support, a given requirement for VMs 604 for each VNF 602 (e.g., of a certain type), a give requirement for resources 608 to support each VM 604 (e.g., of a certain type), rules dictating the assignment of resources 608 to one or more VMs 604 (e.g., affinity and anti-affinity rules), the chasses 610 and servers 612 of hardware platform 606, and the individual resources 608 of each chassis 610 or server 612 (e.g., of a certain type), an integer programming problem may be formulated.

As described herein, a telecommunications system wherein management and control utilizing a software designed network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a telecommunications system in which service level performance in a software defined network as disclosed herein may be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes an device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

In describing preferred methods, systems, or apparatuses of the subject matter of the present disclosure—service level performance in a software defined network—as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed invention, including making and using any devices or systems and performing any incorporated methods. The patentable scope of the invention is defined by the claims, and may include other examples that occur to those skilled in the art (e.g., skipping steps, combining steps, or adding steps between exemplary methods disclosed herein, such as FIG. 3-FIG. 5). Such other examples are intended to be within the scope of the claims if they have structural elements that do not differ from the literal language of the claims, or if they include equivalent structural elements with insubstantial differences from the literal languages of the claims.

Methods, systems, and apparatuses, among other things, as described herein may provide for obtaining a first request, the first request associated with creating a latency zone associated with a base station; based on the first request, determining latency measurements between a base station and a plurality of network devices, wherein a first network device and a second device house a service; and mapping the latency measurements between the base station and the plurality of network devices to a latency zone for the base station. The method, system, computer readable storage medium, or apparatus may obtain a second request for use of a service, wherein the request comprises a location of the use of the service; and based on the second request, determine that the base station is within the geographic location. The method, system, computer readable storage medium, or apparatus may, based on the determine that the base station is within the geographic region, provide a predetermined latency zone for the service relative to the base station, wherein no latency test was necessarily conducted after the second request and before the provide of the predetermined latency zone for the service relative to the base station. It is contemplated that the predetermined latency mapping that were calculated before are probably still in effect and no need to do subsequent testing or calculation of measurement. Based on the service being within requirements comprised in the second request, may instantiate a virtual network function for implementing the service. The method, system, computer readable storage medium, or apparatus may obtain a second request for use of a service, wherein the request comprises a location of the use of the service and maximum latency for the service; based on the second request, determine that the base station is within the geographic location; and based on the service being within requirements comprised in the second request, instantiate a virtual network function for implementing the service. The method, system, computer readable storage medium, or apparatus may detect a configuration change of a network that comprises the base station; and based on the configuration change of the network that comprises the base station, recalibrate the latency zone to account for the configuration change. The method, system, computer readable storage medium, or apparatus may detect a change in a performance indicator for the base station; and based on the change in the performance indicator for the base station, recalibrate the latency zone to account for the change in the performance indicator. All combinations in this paragraph (including the removal or addition of steps) are contemplated in a manner that is consistent with the other portions of the detailed description.

Methods, systems, and apparatuses, among other things, as described herein may provide for obtaining a first request, the first request associated with creating a latency zone associated with a network access point (e.g., base station); based on the first request, determining latency measurements between a network access point and a plurality of network devices; and mapping the latency measurements between the network access point or base station and the plurality of network devices to a latency zone for the network access point. Methods, systems, and apparatuses, among other things, as described herein may provide for obtaining a second request for use of a service, wherein the request comprises a location of the use of the service and maximum latency for the service; based on the second request, determining that the network access point is within the geographic location; and based on the service being within requirements comprised in the second request, instantiating a plurality of virtual network functions for implementing the service along a path between the network access point and an end network device, wherein the end network device is a server. The method, system, computer readable storage medium, or apparatus may provide for obtaining a second request for use of a service, wherein the request comprises a location of the use of the service; and based on the second request, determining that the network access point is within the geographic location. The method, system, computer readable storage medium, or apparatus may provide for obtaining a second request for use of a service, wherein the request comprises a location of the use of the service; based on the second request, determining that the network access point is within the geographic location; and based on the determining that the network access point is within the geographic region, providing a predetermined latency zone for the service relative to the network access point. The method, system, computer readable storage medium, or apparatus may provide for obtaining a second request for use of a service, wherein the request comprises a location of the use of the service or maximum latency for the service (among other things herein); based on the second request, determining that the network access point is within the geographic location; and based on the service being within requirements comprised in the second request, instantiating a virtual network function for implementing the service. The method, system, computer readable storage medium, or apparatus may provide for detecting a configuration change of a network that comprises the network access point; and based on the configuration change of the network that comprises the network access point, recalibrating the latency zone to account for the configuration change. The method, system, computer readable storage medium, or apparatus may provide for detecting a change in a performance indicator for the network access point; and based on the change in the performance indicator for the network access point, recalibrating the latency zone to account for the change in the performance indicator. An apparatus (e.g., network device) may be physical or virtual. In an example, virtual function can be accessed or instantiated in near real-time. All combinations in this paragraph (including the removal or addition of steps) are contemplated in a manner that is consistent with the other portions of the detailed description.

What is claimed:

1. A network device, the network device comprising:
a processor; and
a memory coupled with the processor, the memory comprising executable instructions that when executed by the processor cause the processor to effectuate operations comprising:
obtaining a first request, the first request associated with creating a latency zone associated with a network access point;
based on the first request, determining latency measurements between the network access point and a plurality of network devices; and
mapping the latency measurements between the network access point and the plurality of network devices to a latency zone for the network access point.

2. The network device of claim 1, the operations further comprising:
obtaining a second request for use of a service, wherein the request comprises a geographic location of the use of the service; and
based on the second request, determining that the network access point is within the geographic location.

3. The network device of claim 1, the operations further comprising:
obtaining a second request for use of a service, wherein the request comprises a geographic location of the use of the service;
based on the second request, determining that the network access point is within the geographic location; and
based on the determining that the base station is within the geographic region, providing a predetermined latency zone for the service relative to the network access point.

4. The network device of claim 1, the operations further comprising:
obtaining a second request for use of a service, wherein the request comprises a location of the use of the service;
based on the second request, determining that the network access point is within the geographic location; and
based on the service being within requirements comprised in the second request, instantiating a virtual network function for implementing the service.

5. The network device of claim 1, the operations further comprising:
obtaining a second request for use of a service, wherein the request comprises a geographic location of the use of the service and maximum latency for the service;
based on the second request, determining that the network access point is within the geographic location; and
based on the service being within requirements comprised in the second request, instantiating a virtual network function for implementing the service.

6. The network device of claim 1, the operations further comprising:
detecting a configuration change of a network that comprises the network access point; and
based on the configuration change of the network that comprises the network access point, recalibrating the latency zone to account for the configuration change.

7. The network device of claim 1, the operations further comprising:
detecting a change in a performance indicator for the network access point; and
based on the change in the performance indicator for the network access point, recalibrating the latency zone to account for the change in the performance indicator.

8. The network device of claim 1, wherein the network access point is a base station.

9. The network device of claim 1, the operations further comprising:
obtaining a second request for use of a service, wherein the request comprises a location of the use of the service and maximum latency for the service;
based on the second request, determining that the network access point is within the geographic location; and
based on the service being within requirements comprised in the second request, instantiating a plurality of virtual network functions for implementing the service along a path between the network access point and an end network device, wherein the end network device is a server.

10. The network device of claim 1, wherein the network device is virtual.

11. A system comprising:
a network access point; and
a network device communicatively connected with the network access point, the network device comprising:
a processor; and
a memory coupled with the processor, the memory comprising executable instructions that when executed by the processor cause the processor to effectuate operations comprising:
obtaining a first request, the first request associated with creating a latency zone associated with a network access point;
based on the first request, determining latency measurements between the network access point and a plurality of network devices; and
mapping the latency measurements between the network access point and the plurality of network devices to a latency zone for the network access point.

12. The system of claim 11, the operations further comprising:
obtaining a second request for use of a service, wherein the request comprises a geographic location of the use of the service; and
based on the second request, determining that the network access point is within the geographic location.

13. The system of claim 11, the operations further comprising:
obtaining a second request for use of a service, wherein the request comprises a geographic location of the use of the service;
based on the second request, determining that the network access point is within the geographic location; and
based on the determining that the base station is within the geographic region, providing a predetermined latency zone for the service relative to the network access point.

14. The system of claim 11, the operations further comprising:
obtaining a second request for use of a service, wherein the request comprises a geographic location of the use of the service;
based on the second request, determining that the network access point is within the geographic location; and
based on the service being within requirements comprised in the second request, instantiating a virtual network function for implementing the service.

15. The system of claim 11, the operations further comprising:
obtaining a second request for use of a service, wherein the request comprises a geographic location of the use of the service and maximum latency for the service;
based on the second request, determining that the network access point is within the geographic location; and
based on the service being within requirements comprised in the second request, instantiating a virtual network function for implementing the service.

16. The system of claim 11, the operations further comprising:
detecting a configuration change of a network that comprises the network access point; and
based on the configuration change of the network that comprises the network access point, recalibrating the latency zone to account for the configuration change.

17. The system of claim 11, the operations further comprising:
detecting a change in a performance indicator for the network access point; and
based on the change in the performance indicator for the network access point, recalibrating the latency zone to account for the change in the performance indicator.

18. The system of claim 11, wherein the network access point is a base station.

19. The system of claim 11, the operations further comprising:
obtaining a second request for use of a service, wherein the request comprises a location of the use of the service and maximum latency for the service;
based on the second request, determining that the network access point is within the geographic location; and
based on the service being within requirements comprised in the second request, instantiating a plurality of virtual network functions for implementing the service along a path between the network access point and an end network device, wherein the end network device is a server.

20. The system of claim 11, wherein the network device is virtual.
